(19) United States
(12) Patent Application Publication
(10) Pub. No.: US 2026/0319863 A1
(43) Pub. Date: Oct. 15, 2026

(54) MANAGEMENT OF WORKLOADS IN A COMPUTING INFRASTRUCTURE

(71) Applicant: Hewlett Packard Enterprise Development LP, Spring, TX (US)

(72) Inventor: Ranjeet Kumar Sharma, Bangalore (IN)

(21) Appl. No.: 19/232,154

(22) Filed: Jun. 9, 2025

(30) Foreign Application Priority Data
Apr. 10, 2025 (IN) 202541035102

(51) Int. Cl. G06F 9/50

(52) U.S. Cl. CPC G06F 9/5088; G06F 9/5094

(57) ABSTRACT

Examples described herein relate to a method and workload management system for managing workloads in a computing infrastructure. The workload management system receives thermal metrics from a plurality of computing nodes over a first predefined duration. The workload management system then determines patterns of variations in these thermal metrics. Based on predictive analysis, the workload management system identifies candidate computing nodes whose thermal metrics are expected to rise above a first threshold and target computing nodes whose thermal metrics are expected to remain below a second, lower threshold over a second predefined duration. Finally, the workload management system migrates one or more workloads from the candidate nodes to the target nodes to improve the thermal performance of the computing infrastructure.

### BACKGROUND

Workloads are virtual computing resources that bundle useful information, such as resource allocations (e.g., compute, storage, etc.), data, instructions, etc., into a single executable unit for an application to run in any computing environment. Workload management applications facilitate the creation, deployment, and/or management of workloads. For instance, a workload orchestrator such as Kubernetes can be implemented in an IT infrastructure to enable deployment and management (e.g., migration, scaling, load balancing) of workloads (e.g., containers and pods) running on various computing resources.

A workload management application generally includes workload management services, such as a scheduler responsible for deploying and managing the workloads in a cluster of computing nodes. For instance, upon receiving the request to deploy a workload, the scheduler determines resource availability in the cluster to determine if the workload can be deployed on any of the computing nodes in the cluster. Generally, computing nodes are configured with a predetermined, fixed number of resources, and the resource availability of each computing node depends on the existing workloads hosted on that particular computing node. The workload's deployment on inappropriate computing may lead to poor thermal performance and impact the overall performance of the computing node and the cluster.

### BRIEF DESCRIPTION OF THE DRAWINGS

Features, aspects, and advantages of the present specification will become better understood when the following detailed description is read with reference to the accompanying drawings, in which like characters represent like parts throughout the drawings.

FIG. 1A depicts a system in which various of the examples presented herein may be implemented.

FIG. 1B depicts a cluster configuration in the system of FIG. 1A after the migration of an existing workload.

FIG. 2 depicts a flow diagram of an example method for managing workload migration.

FIG. 3 depicts a flow diagram of another example method for managing workload migration.

FIG. 4 depicts a block diagram of an example workload management system in which various examples described herein may be implemented.

It is emphasized that, in the drawings, various features are not drawn to scale. In fact, in the drawings, the dimensions of the various features have been arbitrarily increased or reduced for clarity of discussion.

### DETAILED DESCRIPTION

When computing nodes (e.g., servers and storage systems) host and execute workloads, they inherently generate heat as a byproduct of their operation. These workloads generally include virtual machines (VMs), containers, pods, or software applications. Under heavy processing loads, it may be challenging to run these workloads seamlessly while minimizing heat dissipation. Inadequate thermal management can precipitate a cascade of issues, including hardware failures and operating system crashes. Contemporary solutions for managing these workloads typically optimize the allocation and utilization of CPU, memory, and networking resources within individual servers or across clusters and cloud infrastructures.

Historically, server hardware was often a limiting factor due to constrained resources such as lower counts of CPUs, memory, and networking interfaces. However, advancements in server technology have significantly alleviated these bottlenecks. Modern data center infrastructures are now equipped with comparatively substantially higher computational and memory capacities, shifting the focus toward the efficient management of thermal output and carbon emissions during workload execution. As thermal dissipation escalates, system performance typically degrades, adversely affecting workload efficiency and overall data center productivity. This inefficiency not only escalates operational costs but also has profound environmental repercussions.

For instance, workloads such as VMs and containers typically leverage the available resources on respective host computing nodes to execute their respective functions. In instances where workloads require more resources than initially provisioned, dynamic resource allocation becomes indispensable. However, this approach can be suboptimal for workloads that are not resource-intensive, leading to resource underutilization and increased thermal dissipation. Inefficient resource usage results in excessive heat generation, which can degrade server performance and pose risks to hardware integrity. This inefficiency impacts customer business operations and contributes to higher carbon emissions, undermining efforts towards environmental sustainability.

In accordance with examples of the present disclosure, a method and a workload management system are proposed for effectively managing the execution of the workloads in a cluster of computing nodes, thereby improving their thermal management. In particular, the proposed solution entails workload scheduling based on predictive analysis using machine learning models, which predicts heat dissipation within computing nodes or clusters of computing nodes. More specifically, the proposed solution entails migrating workloads to an appropriate host computing node by incorporating heat dissipation parameters into the monitoring process, which are collected from individual computing nodes or clusters within a cloud infrastructure. By predicting which computing nodes will dissipate less heat, the proposed solution intelligently schedules and deploys workloads to optimize the thermal efficiency of the computing nodes. This advanced predictive capability not only improves the overall efficiency of servers but also significantly reduces heat dissipation. Lower heat output extends the lifespan of hardware components and minimizes the need to run cooling systems (e.g., fans) at high speeds, thereby decreasing the operational costs associated with data center cooling systems.

In some examples, the proposed method entails managing workloads in a computing infrastructure utilizing thermal metrics to optimize the performance and efficiency of the system. The method begins with a workload management system receiving thermal metrics from multiple computing nodes within the computing infrastructure. These thermal metrics are gathered over a first predefined duration, providing the workload management system with a detailed view of the thermal behavior of each node over the first predefined duration. Once the thermal metrics are collected, the workload management system analyzes the thermal metrics to determine patterns of variation for each computing node during the first predefined period. This analysis is useful in understanding the thermal dynamics within the computing infrastructure and identifying computing nodes that may be prone to overheating. The workload management system uses predictive analysis techniques to forecast future thermal behavior based on the identified patterns.

From this predictive analysis, the workload management system may identify at least two sets of computing nodes, for example, a set of candidate computing nodes and a set of target computing nodes. The set of candidate computing nodes may include those computing nodes whose thermal metrics are expected to rise above a certain threshold within a second predefined duration. These computing nodes may be at risk of overheating and potentially causing performance degradation or hardware failures. On the other hand, the set of target computing nodes may include computing nodes whose thermal metrics are predicted to remain below a lower threshold during the same period. These nodes are deemed to be thermally stable and capable of handling additional workloads without exceeding safe temperature limits.

To enhance the thermal performance of the computing infrastructure, the workload management system migrates one or more workloads from the set of candidate nodes to the set of target computing nodes. This migration mitigates the risk of overheating by redistributing the thermal load more evenly across the infrastructure. By proactively managing the thermal load in this manner, the method helps to maintain optimal operating temperatures, thereby improving the overall efficiency and reliability of the computing nodes in the computing infrastructure.

As will be appreciated, the proposed workload management system may not only prevent potential thermal-related issues but also extend the lifespan of the hardware by avoiding excessive heat exposure. Additionally, reducing the need for intensive cooling measures can lead to significant cost savings in data center operations. Integrating thermal metrics into the workload management process provides a sophisticated and effective solution for maintaining the health and performance of a computing infrastructure.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

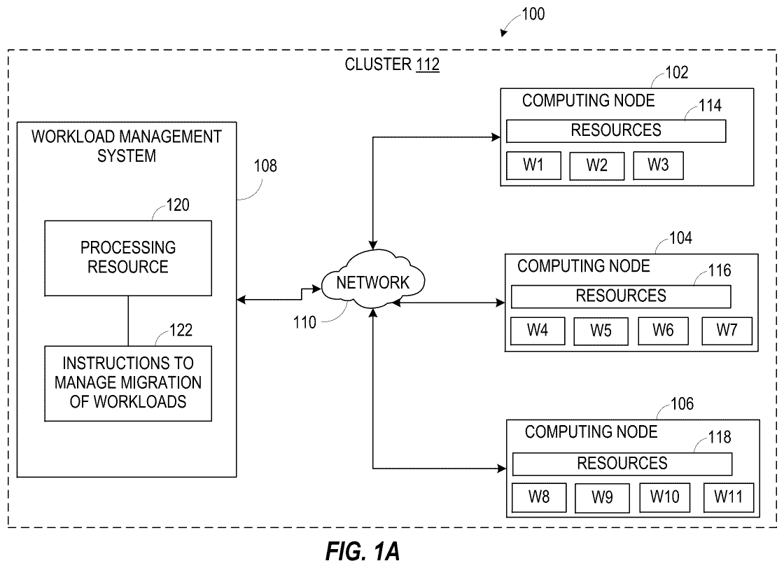

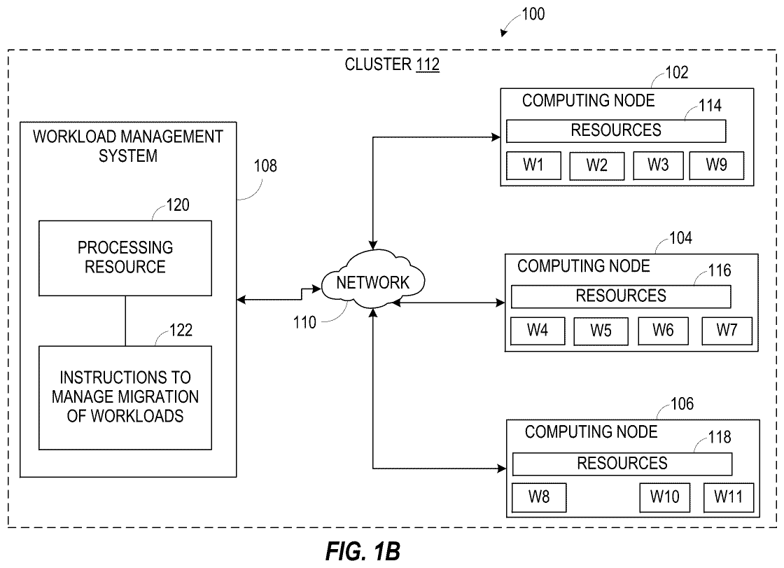

Before describing examples of the disclosed systems and methods in detail, it is useful to describe an example network installation with which these systems and methods might be implemented in various applications. FIG. 1A illustrates a system 100 in which various examples presented herein may be implemented. The system 100 may be a networked system that includes a plurality of computing nodes 102, 104, and 106 (hereinafter collectively referred to as computing nodes 102-106) and a workload management system 108. The computing nodes 102-106 may be communicatively coupled to the workload management system 108 via a network 110. In one example, the computing nodes 102-106 and the workload management system 108 may form a computing infrastructure also referred to as a cluster of computing nodes, hereinafter referred to as a cluster 112 (marked with a dashed box). The cluster 112 may be implemented as a private cloud, a public cloud, or a hybrid cloud.

The system 100 may be a distributed system where one or more of the computing nodes 102-106 and the workload management system 108 are located at physically distinct locations (e.g., on different racks, on different enclosures, in different buildings, in different cities, in different countries, and the like) while being connected via the network 110. In certain other examples, the system 100 may be a turnkey solution or an integrated product. In some examples, the terms “turnkey solution” or “integrated product” may refer to a ready-for-use packaged solution or product where the computing nodes 102-106, the workload management system 108, and the network 110 are all disposed within a common enclosure or a common rack. Moreover, in some examples, the system 100 in any form, be it the distributed system, the turnkey solution, or the integrated product, may be capable of being reconfigured by adding or removing computing nodes and/or by adding or removing internal resources (e.g., compute, storage, network cards, etc.) to and from the computing nodes 102-106 and the workload management system 108.

Examples of the network 110 may include, but are not limited to, an Internet Protocol (IP) or non-IP-based local area network (LAN), wireless LAN (WLAN), metropolitan area network (MAN), wide area network (WAN), a storage area network (SAN), a personal area network (PAN), a cellular communication network, a Public Switched Telephone Network (PSTN), and the Internet. In some examples, the network 110 may include one or more network switches, routers, or network gateways to facilitate data communication. Communication over the network 110 may be performed in accordance with various communication protocols, such as, but not limited to, Transmission Control Protocol and Internet Protocol (TCP/IP), User Datagram Protocol (UDP), the Institute of Electrical and Electronics Engineers (IEEE) 802.11, and/or cellular communication protocols. The communication over the network 110 may be enabled via wired (e.g., copper, optical communication, etc.) or wireless (e.g., Wi-Fi®, cellular communication, satellite communication, Bluetooth, etc.) communication technologies. In some examples, the network 110 may be enabled via private communication links, including, but not limited to, communication links established via Bluetooth, cellular communication, optical communication, radio frequency communication, wired (e.g., copper), and the like. In some examples, the private communication links may be direct communication links between the workload management system 108 and the computing nodes 102-106.

Each of the computing nodes 102-106 may be a system including one or more processors, microcontrollers, electronic storage devices, and/or any other electronic components that may facilitate various computing and/or data storage services. Examples of the computing nodes 102-106 may include, but are not limited to, a desktop computer, a laptop, a smartphone, a server, a computer appliance, a workstation, a storage system, or a converged or hyperconverged system, and the like. Although the cluster 112 is shown to include three computing nodes 102-106, the cluster 112 may include any number of computing nodes, without limiting the scope of the present disclosure. The computing nodes 102-106 may have similar or varying hardware and/or software configurations in a given implementation of the cluster 112. By way of example, while some computing nodes may have high-performance computing capabilities, some computing nodes may facilitate strong data security, some computing nodes may facilitate low-latency data read and/or write operations, certain computing nodes may have enhanced thermal capabilities, some computing nodes may be good at handling database operations, or some computing nodes may be good at handling graphics processing operations. Furthermore, although the implementation of the system 100 depicts the workload management system 108 as part of the cluster 112, in some other example implementations, the workload management system 108 may be deployed outside of the cluster 112, without limiting the scope of the present disclosure.

The computing nodes 102-106 may facilitate resources such as compute, storage, graphics, and/or networking capabilities for one or more workloads to execute on them. The workloads hosted in cluster 112 are denoted as W1, W2, W3, W4, W5, W6, W7, W8, W9, W10, and W11 (hereinafter collectively referred to as workloads W1-W11). These workloads W1-W11 may represent virtual computing resources that consolidate useful information, including resource allocations (e.g., compute, storage, etc.), data, instructions, etc., into a single executable unit for an application to operate within any computing environment. Examples of the workloads W1-W11 may encompass virtual machines, containers, pods, computer applications, databases, virtual data stores, logical disks, or combinations thereof. In several illustrative examples described hereafter, the workloads W1-W11 may be described as containers or virtual machines, although the discussed examples may also apply to other types of workloads.

Further, although not shown in FIG. 1A, in an example implementation with workload resources being containers, the computing nodes 102-106 may host container management services, for example, Kubernetes components to facilitate a runtime environment for the containers. Example Kubernetes components that may be hosted on the computing nodes 102-106 may include Kubelet (e.g., a software agent to monitor containers), Kube-proxy (e.g., a network proxy to manage communications with containers), and a container runtime (e.g., software that is responsible for creating and running containers). Likewise, to support other types of workloads, the computing nodes 102-106 may host respective runtime applications and/or other relevant management and monitoring applications, without limiting the scope of the present disclosure.

For illustration purposes, in the example of FIG. 1A, the computing node 102 is shown to host the workloads W1, W2, and W3; the computing node 104 is shown to host the workloads W4, W5, W6, and W7; and the computing node 106 is shown to host the workloads W8, W9, W10, and W11. Although a certain number of workloads are shown as being hosted on each of the computing nodes 102-106 as depicted in FIG. 1A, the computing nodes 102-106 may host any number of workloads depending on the respective hardware and/or software configurations. Further, the computing nodes 102, 104, and 106 may be configured with resources 114, 116, and 118, respectively. In some examples, the resources 114, 116, and 118 may include CPUs, GPUs, storage devices, and/or network ports that may allow the workloads W1-W11 to function. For illustration purposes, in the description hereinafter, the resources 114, 116, and 118 are described as including CPUs and memory.

As it is understood, the execution of the workloads W1-W11 on the computing nodes 102-106 generates heat. For example, the execution of a workload demands computational resources such as CPUs, memory, and GPUs, which, during their operation, dissipate heat. The intensity of this heat generation varies depending on the computational intensity and efficiency of the workloads. For instance, workloads involving heavy computations, such as data processing or graphics rendering, typically generate more heat than those with less intensive operations.

Table-1, presented below, depicts a snapshot of a system configuration illustrating example resource configuration of the computing nodes 102, 104, and 106, example resource allocations to the workloads W1-W11, and example respective heat dissipations (in kilowatts (KW)). For ease of illustration, in this example, the resources are described as being CPUs and Memory. It may be noted that, in some examples, additional or fewer resources may be considered to decide on the migration of the workloads. Also, in certain other examples, the thermal metrics may be the temperatures of the computing nodes 102-106 measured in Celsius (° C.), Fahrenheit (° F.), and Kelvin (K), without limiting the scope of the present disclosure.

TABLE 1
Example snapshot of system configuration

| | | | Allo- | | | | |
|---|---|---|---|---|---|---|---|
| | | Allo- | cated | Workload | | Total Heat | |
| Computing | Work- | cated | Memory | Heat | | Dissipation | |
| node | loads | CPUs | (GB) | Dissipation | | (kW) | |
| 102 (64 | W1 | 8 | 32 | 3 | kW | 9 | kW |
| CPUs; 1028 | W2 | 12 | 32 | 3 | kW | | |
| GB Memory) | W3 | 8 | 32 | 3 | kW | | |
| 104 (64 | W4 | 4 | 32 | 2 | kW | 10 | kw |
| CPUs; 1028 | W5 | 2 | 64 | 2 | kW | | |
| GB Memory) | W6 | 8 | 128 | 3 | kW | | |
| | W7 | 10 | 256 | 3 | kW | | |
| 106 (64 | W8 | 12 | 128 | 10 | kW | 43 | kW |

| | | | | | |
|---|---|---|---|---|---|
| CPUs; 1028 | W9 | 24 | 512 | 20 | kW |
| GB Memory) | W10 | 12 | 128 | 8 | kW |
| | W11 | 12 | 128 | 5 | kW |

As illustrated in the first column of Table-1, in an example implementation of the system 100, each of the computing nodes 102-106 may have a similar resource configuration, wherein each of the computing nodes 102-106 is equipped with 64 CPUs and 1028 GB of memory. The columns “Allocated CPUs” and “Allocated memory” represent example allocations of CPUs and memory to each of the workloads W1-W11. It is evident from the resource allocation presented in Table-1 that computing node 106 is more heavily utilized compared to the other computing nodes. Furthermore, due to the higher individual heat dissipation by the workloads W8-W11 hosted on computing node 106, the computing node 106 exhibits greater heat dissipation relative to computing nodes 102 and 104.

Effective management of this thermal load is useful to prevent overheating, which may compromise the performance and reliability of the computing nodes if not effectively managed. The thermal load from each workload needs to be continuously monitored and managed to ensure that the temperature remains within optimal operating ranges. This is particularly useful in a clustered environment where multiple computing nodes 102-106 are working together, as the heat generated by one computing node can affect the overall temperature of the cluster 112. To that end, the workload management system 108 is configured to effectively manage the execution of the workloads W1-W11 in the cluster 112, thereby improving the thermal management of the computing nodes 102-106.

In particular, the workload management system 108 may schedule the workloads on an appropriate computing node that may eventually reduce the heat dissipation of the computing nodes in the cluster 112. The workload management system 108 may do so based on predictive analysis of the heat dissipation by different workloads using machine learning models. More specifically, the workload management system 108 may migrate workloads to an appropriate host computing node by incorporating heat dissipation parameters into the monitoring process, which are collected from individual computing nodes 102-106 in a cloud infrastructure. By predicting which computing nodes will dissipate less heat, the proposed solution intelligently schedules and deploys workloads to optimize the thermal efficiency of the computing nodes 102-106. This advanced predictive capability not only improves the overall efficiency of computing nodes 102-106 but also significantly reduces their heat dissipation. Lower heat output extends the lifespan of hardware components and minimizes the need to run cooling systems (e.g., fans) at high speeds, thereby decreasing the operational costs associated with data center cooling systems.

In some examples, the workload management system 108 may be a device including a processor, microcontroller and/or any other electronic component, or a device or system that may facilitate various compute and/or data storage services, for example, and/or in particular, the management of the workloads on the computing nodes 102-106. Examples of the workload management system 108 may include, but are not limited to, a desktop computer, a laptop, a smartphone, a server, a computer appliance, a workstation, a storage system, or a converged or hyperconverged system, and the like that is configured to manage the deployment and scheduling of the workloads W1-W11 on the computing nodes 102-106. Further, in certain examples, the workload management system 108 may be implemented as a virtual machine or a containerized application executing on hardware in the system 100. In one example, the workload management system 108 may be implemented as a virtual machine or a containerized application on any of the computing nodes 102-106 in the system 100. Further, in an example implementation where the workloads W1-W11 are containers, the workload management system 108 may host one or more container orchestrator services, for example, Kubernetes control plane services. In one example, the container orchestrator services may facilitate the deployment and management of containers on the computing nodes 102-106.

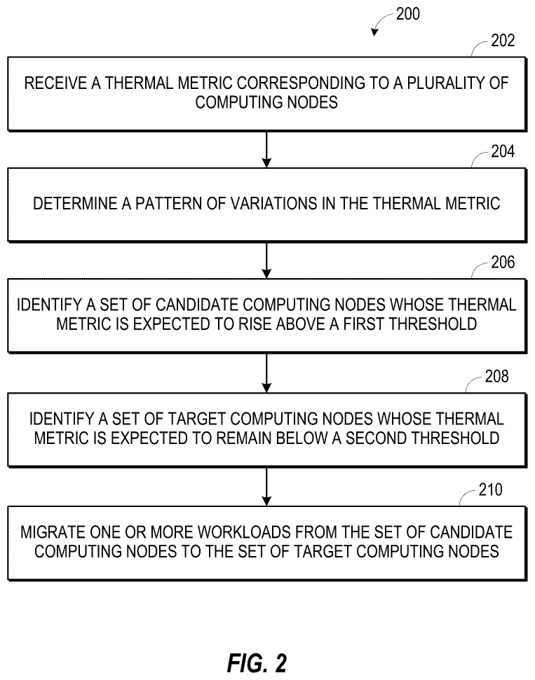

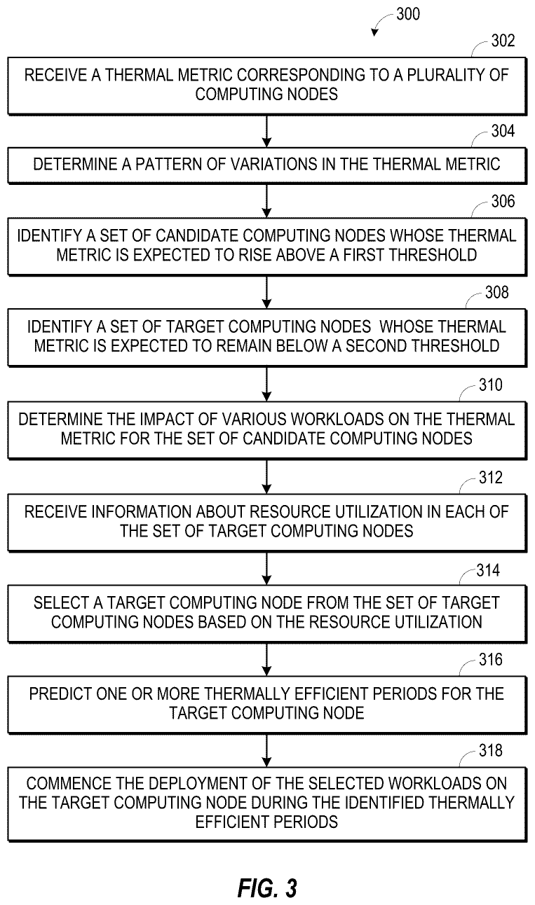

In some examples, the workload management system 108 may include a processing resource 120 and/or instructions 122 to manage deployment of the workloads. In some examples, the processing resource 120 may be an integrated system, such as a microcontroller with pre-stored instructions 122. In some examples, the instructions may be stored in a storage medium separate from the processing resource, for example, in a machine-readable storage medium. Such machine-readable storage medium is a non-transitory medium that is tangible and is alternatively referred to as a non-transitory machine-readable storage medium that does not encompass transitory propagating signals. The machine-readable storage medium may be any electronic, magnetic, optical, or other storage device that may store data and/or executable instructions. Examples of the machine-readable storage medium that may be used in the workload management system 108 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. In some examples, by executing the instructions 122, the processing resource may be able to execute the methods described in FIGS. 2 and 3, and/or any other functions intended to be performed by the workload management system 108.

The processing resource 120 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium, or combinations thereof. The processing resource 120 may fetch, decode, and execute the instructions 122 stored in the machine-readable storage medium to generate compact headers for the data units transmitted by the workload management system 108. As an alternative or in addition to executing the instructions 122, the processing resource 120 may include at least one integrated circuit (IC), control logic, electronic circuits, or combinations thereof that include a number of electronic components for performing the functionalities intended to be performed by the workload management system 108.

In example implementations where the workload management system 108 is implemented as a virtual resource, such as a virtual machine, a container, a pod, or the like, the processing resource 120 and the machine-readable storage medium may be example representatives of a processor and a machine-readable storage medium of a host computing system that hosts the workload management system 108 as the virtual resource.

To enable effective thermal management in the cluster 112, the workload management system 108 may receive thermal metrics from the computing nodes 102-106 over a first predefined duration, providing the workload management system 108 with a detailed view of the thermal behavior of each of the computing nodes 102-106 over the first predefined duration. In some examples, the thermal metrics collected by the workload management system 108 may provide a quantitative measure of heat dissipation (for example, measured in kW) from each computing node in the cluster 112. Once the thermal metrics are collected, the workload management system 108 may analyze the thermal metrics to determine patterns of variation for each computing node during the first predefined period. This analysis is useful in understanding the thermal dynamics within the computing infrastructure and identifying computing nodes that may be prone to overheating. The workload management system uses predictive analysis techniques to forecast future thermal behavior based on the identified patterns.

From this predictive analysis, the workload management system 108 may identify at least two sets of computing nodes, for example, a set of candidate computing nodes and a set of target computing nodes. The set of candidate computing nodes may include those computing nodes whose thermal metrics are expected to rise above a certain threshold within a second predefined duration. These computing nodes may be at risk of overheating and potentially causing performance degradation or hardware failures. On the other hand, the set of target computing nodes may include computing nodes whose thermal metrics are predicted to remain below a lower threshold during the same period. These nodes are deemed to be thermally stable and capable of handling additional workloads without exceeding safe temperature limits. In an example system configuration based on Table 1, the workload management system 108 may determine that the computing node 106 may be at a much higher risk of thermal overload compared to the computing nodes 102 and 104. Accordingly, the workload management system 108 may classify the computing node 106 as a candidate computing node and computing nodes 102 and 104 as the target computing nodes.

To enhance the thermal performance of the cluster 112, the workload management system 108 may then migrate one or more workloads from the set of candidate nodes to the set of target computing nodes. This migration mitigates the risk of overheating by redistributing the thermal load more evenly across the infrastructure. By proactively managing the thermal load in this manner, the method helps to maintain optimal operating temperatures, thereby improving the overall efficiency and reliability of the computing nodes in the computing infrastructure. By way of example, the workload management system 108 may migrate one or more workloads from the target computing system 106 to the set of target computing nodes comprising the computing nodes 102 and 104.

Table 2, presented below, depicts a snapshot of the system configuration illustrating example resource configuration of the computing nodes 102, 104, and 106, example resource allocations to the workloads W1-W11, and example respective heat dissipations, after migrating the workload W9 to the target computing node 102.

TABLE 2
Example snapshot of system configuration after migration of W9

| | | | Allo- | | | |
|---|---|---|---|---|---|---|
| | | Allo- | cated | Workload | | |
| Computing | Work- | cated | Memory | Heat | | Total Heat |
| node | loads | CPUs | (GB) | Dissipation | | Dissipation |
| 102 (64 | W1 | 8 | 32 | 3 | kW | 29 kW |
| CPUs; 1028 | W2 | 12 | 32 | 3 | kW | |
| GB Memory) | W3 | 8 | 32 | 3 | kW | |
| | W9 | 24 | 512 | 20 | kW | |
| 104 (64 | W4 | 4 | 32 | 2 | kW | 10 kw |
| CPUs; 1028 | W5 | 2 | 64 | 2 | kW | |
| GB Memory) | W6 | 8 | 128 | 3 | kW | |
| | W7 | 10 | 256 | 3 | kW | |
| 106 (64 | W8 | 12 | 128 | 10 | kW | 23 kW |
| CPUs; 1028 | W10 | 12 | 128 | 8 | kW | |
| GB Memory) | W11 | 12 | 128 | 5 | kW | |

After the workload W9 is migrated to the computing node 102, the thermal load on the computing system may reduce by 20 KW, resulting in the overall thermal load on the computing node 106 to 23 KW. Referring now to FIG. 1B, FIG. 1B depicts the system 100 of FIG. 1A after the migration of a workload. In particular, FIG. 1B represents a configuration or a state of the cluster 112 after the migration of the workload W9 from the computing node 106 to the computing node 102.

As will be appreciated, to allow a user (e.g., an administrator of the networked system 100) flexibility for personalization, one or more of the first predefined duration, the second predefined duration, the first threshold, or the second threshold may be made customizable. In particular, in some examples, the workload management system 108 may enable a user interface for the user (e.g., via a display or any other interactive media) to make modifications in one or more of the first predefined duration, the second predefined duration, the first threshold, or the second threshold.

Additional details of the operations performed by the workload management system 108 are described in conjunction with the methods described in FIGS. 2 and 3.

As will be appreciated, the benefits of this workload migration are multifaceted. Reducing the thermal load on computing nodes at risk of overheating enhances hardware longevity by preventing thermal stress and potential damage. Further, distributing workloads to nodes with available thermal capacity helps maintain optimal operating temperatures, thus improving system performance and reliability. Additionally, this proactive thermal management approach reduces the need for aggressive cooling measures, leading to significant cost savings in data center operations. By optimizing thermal performance through intelligent workload migration, the infrastructure can achieve a balance between high performance, operational reliability, and environmental sustainability. This method ensures that the data center operates efficiently, even under varying workload conditions, providing a robust solution to the challenges of thermal management in modern computing environments.

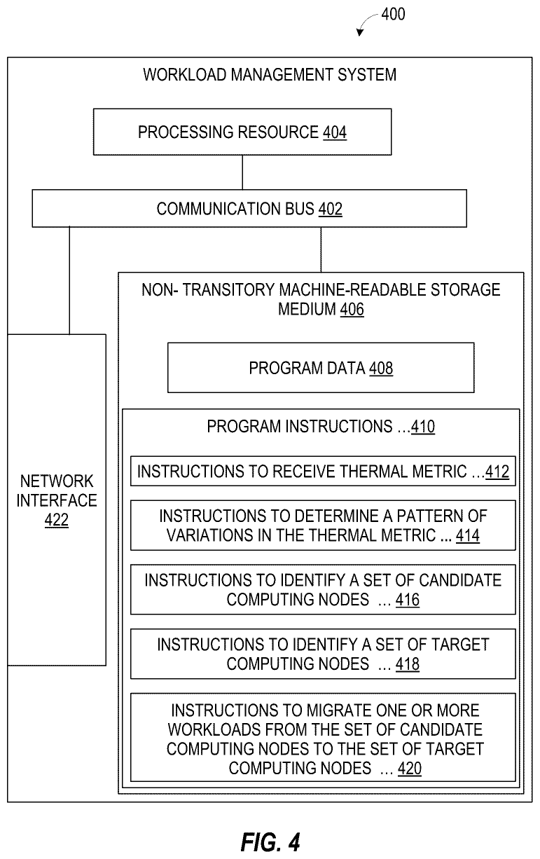

Referring now to FIG. 2, a flow diagram of an example method 200 for managing workload deployment is presented. The method 200 may include steps 202, 204, 206, 208, and 210 (hereinafter collectively referred to as steps 202-210) that may be performed by a workload management system, for example, the workload management system 108 of FIG. 1. In certain examples, operations at blocks 202-210 may be performed by the processing resource by executing one or more of the instructions stored in the machine-readable storage medium (see FIG. 4, for example). For ease of illustration, the method 200 of FIG. 2 is described in conjunction with FIGS. 1A and 1B. However, details and/or examples presented herein should not be construed to be limited by the specifics of FIGS. 1A and 1B.

The workload management system may execute the method 200 for managing workloads (e.g., the workloads W1-W11) in a computing infrastructure (e.g., the cluster 112).

At step 202, the workload management system may receive thermal metrics corresponding to a plurality of computing nodes (e.g., the computing nodes 102-106) hosted in the computing infrastructure (e.g., the cluster 112 of FIG. 1) over a first predefined duration. As previously noted, the execution of workloads on the computing nodes can result in the generation of heat by the electronic components inside the computing nodes 102-106. For example, the workload demands computational resources such as CPUs and GPUs, which, during their operation, dissipate heat. The intensity of this heat generation varies depending on the computational intensity and efficiency of the workloads. For instance, workloads that involve heavy computations, such as data processing or graphics rendering, typically generate more heat compared to those with less intensive operations (see Tables 1 and 2).

These thermal metrics collected by the workload management system may provide a quantitative measure of heat dissipation (for example, measured in kilowatts (KW)) from each computing node in the cluster 112. Collecting these thermal metrics involves deploying temperature sensors and thermal monitoring tools within the computing nodes 102-106. These sensors may continuously track the temperature and heat output of the computing nodes 102-106, capturing data at regular or predefined intervals. The computing nodes 102-106 may then communicate this information to the workload management system for further analysis. By way of example, Table-1 in columns “Workload Heat Dissipation” and “Total Heat Dissipation” depicts example thermal metrics collected from the computing systems 102-104.

In some examples, the thermal metrics may be recorded in real-time or near-real-time to create a detailed thermal profile of each computing node 102-106. The first predefined duration over which these metrics are collected is chosen to capture a representative sample of the computing nodes' thermal behavior under various load conditions. This period could range from several hours to days, depending on the variability and the operational patterns of the workloads. By gathering comprehensive thermal data, the workload management system can build a robust baseline for identifying thermal trends and anomalies, setting the stage for predictive analysis and proactive workload management, as will be described in greater detail below.

In some examples, to facilitate the collection and storage of the thermal metrics data, the workload management system may be configured with a local database or configured to access a cloud-hosted database. In some examples, the computing nodes may push logs, including the thermal metrics, to such database(s), and the workload management system may obtain the thermal metrics from the database. Each record in this database may be assigned a unique identifier, which is used to reference a particular record in the database for further analysis by the workload management system.

Further, at step 204, the workload management system may determine a pattern of variations in the thermal metric for each of the plurality of computing nodes 102-106 over the first predefined duration. In some examples, the workload management system may analyze the collected thermal metrics by applying advanced predictive analytics and machine-learning techniques to the thermal metrics. For example, the workload management system may be configured to implement techniques such as time-series analysis, regression models, and artificial neural networks (ANNs) to identify trends, detect anomalies, and predict future thermal behaviors. In some examples, the workload management system may use time-series analysis to understand how the thermal metrics may evolve over time. Further, the regression models may be used to establish relationships between workload intensity and thermal output. Furthermore, the ANNs may be used to enhance prediction accuracy by learning complex patterns in the thermal metrics that may not be immediately apparent through traditional statistical methods. It may be noted that the present disclosure is not restricted to the type of predictive analytics techniques or machine-learning techniques used to determine the pattern of variations in the thermal metric.

Furthermore, at step 206, based on the predictive analysis of the patterns of variation, the workload management system may identify a set of candidate computing nodes from the plurality of computing nodes whose thermal metrics are expected to rise above a first threshold over a second predefined duration. As will be understood, these candidate nodes may be at risk of overheating, posing a threat to system stability and hardware integrity. The first threshold may be a thermal limit beyond which the computing node's performance may degrade, and hardware components might suffer damage. In some examples, the first threshold may be determined based on manufacturer specifications and operational best practices to ensure safe operating conditions for the computing nodes.

Identifying the candidate nodes may entail the workload management system comparing the predicted thermal metrics of the computing nodes against the first threshold. The computing nodes expected to exceed the first threshold may be flagged as a potential risk and are identified as the candidate computing nodes. By predicting which nodes are likely to overheat, the workload management system can plan and execute workload migrations before thermal issues manifest, thereby maintaining system stability and preventing downtime. This preemptive approach helps in safeguarding hardware, improving overall system reliability, and ensuring continuous operation without thermal interruptions. In one example implementation represented via Table-1, the workload management system may identify and classify the computing node 106 as a candidate computing node. Although in the example of Table-1, a single computing node is identified as a candidate computing node, in some other examples, more than one computing node may be identified as a candidate computing node depending on the respective thermal metrics.

Moreover, at step 208, the workload management system may identify a set of target computing nodes from the plurality of computing nodes whose thermal metrics are expected to remain below a second threshold over the same second predefined duration. The second threshold is set lower than the first threshold to ensure that the target nodes have sufficient thermal capacity to handle additional workloads without exceeding safe temperature limits. These target computing nodes may be identified through the same predictive analysis used to determine candidate nodes, ensuring consistency and accuracy in workload management. By identifying target computing nodes, the workload management system ensures that the workload migration process is both effective and efficient. These target nodes are deemed thermally stable and capable of absorbing the additional thermal load from the candidate nodes, balancing the thermal load across the infrastructure, preventing any single node from becoming a thermal hotspot.

In one example implementation represented via Table-1, the workload management system may identify and classify the computing nodes 106 as the target computing nodes. Although in the example of Table-1, two computing nodes are identified as the target computing nodes, in some other examples, greater or fewer computing nodes may be identified as target computing nodes depending on the respective thermal metrics.

In some examples, the identification of the set of candidate computing nodes and the set of target computing nodes entails the workload management system leveraging machine learning models trained on thermal metrics. The first part of this method involves training the machine learning model. In some examples, the workload management system collects values of the thermal metric from the plurality of computing nodes over a third predefined duration. This duration may be selectively chosen to capture a comprehensive set of thermal data under various operational conditions. The collected thermal metrics include detailed temperature readings, heat dissipation rates, and other relevant thermal parameters that reflect the thermal behavior of each node. Using this dataset, the workload management system trains the machine learning model. The training process involves feeding the model with historical thermal data, allowing it to learn patterns, correlations, and trends related to the thermal performance of the computing nodes. Various machine learning techniques, such as supervised learning, unsupervised learning, and reinforcement learning, can be employed to build a robust predictive model. The trained model is then validated and tested to ensure its accuracy and reliability in predicting future thermal behavior.

Once the machine learning model is trained, the workload management system uses it to identify sets of candidate and target computing nodes. For example, the machine learning model may analyze the thermal metrics and infer which nodes are likely to experience a rise in their thermal metrics above a first threshold over a second predefined duration. These nodes, identified as candidate computing nodes, are at risk of overheating and require intervention to prevent thermal-related issues. Furthermore, the machine learning model may infer target computing nodes, which are predicted to maintain their thermal metrics below a second threshold, lower than the first, during the same second predefined duration.

The third predefined duration, which is used for training the machine learning model, may be strategically timed to ensure that the model is well-prepared for real-time workload management. This duration may end prior to the commencement of the first predefined duration or the second predefined duration, ensuring that the model is trained and ready before the actual workload management begins. Alternatively, the third predefined duration can overlap with one or both of the first predefined duration and the second predefined duration. This overlapping allows the model to be continuously updated with new thermal data, enhancing its predictive accuracy and adaptability to changing thermal conditions.

Finally, at step 210, the workload management system may migrate one or more workloads from the set of candidate computing nodes to the set of target computing nodes to improve the thermal performance of the computing infrastructure. This migration process involves transferring the workload data, application states, and relevant configurations from the overheating nodes to the thermally stable nodes. The workload management system may be configured to execute the migration of one or more workloads seamlessly, ensuring continuity of services. Techniques such as live migration can be employed to move workloads without shutting down applications, thereby maintaining uptime and service availability. In one example implementation, one of the workloads, such as the workload W9, may be migrated from the candidate computing node 106 to the target computing node 102. Additional details on selecting a particular target computing node and a particular workload for migration are described in conjunction with the method 300 of FIG. 3.

The workload management system may be configured to carry out the workload migration using industry-standard techniques to ensure minimal disruption and high availability. For workloads such as virtual machines, live migration is commonly used, which allows the VMs to be moved between the computing nodes without downtime, leveraging hypervisors like VMware vSphere, Microsoft Hyper-V, or Kernel-based Virtual Machine (KVM). Similarly, for workloads such as containers, orchestrated environments such as Kubernetes facilitate dynamic migration through pod rescheduling, ensuring seamless service continuity. By transferring workloads from the candidate computing nodes at risk of overheating to the target computing nodes with available thermal capacity, the workload management system not only prevents potential thermal issues but also enhances the overall efficiency and reliability of the cluster. This proactive approach to workload management ensures that the infrastructure operates within optimal thermal parameters, thereby extending hardware longevity, reducing cooling costs, and supporting sustainable data center operations.

Referring now to FIG. 3, a flow diagram of another example method 300 for managing workload deployment is presented. The method 300 may include steps 302, 304, 308, 310, 312, 314, 316, and 318 (hereinafter collectively referred to as steps 302-318) that may be performed by the workload management system. In particular, in some examples, the operations at blocks 302-318 may be performed by the processing resource by executing one or more of the instructions stored in the machine-readable storage medium (see FIG. 4, for example). Further, the method 300 of FIG. 3 is an example representative of the method 200 of FIG. 2 and may include certain additional details and/or additional steps than described in FIG. 2. Certain details of the operations performed at one or more of the steps 302-318 might have already been described in conjunction with FIG. 2, which is not repeated herein for the sake of brevity. Further, for ease of illustration, the method 300 of FIG. 3 is described in conjunction with FIGS. 1A and 1B. However, details and/or examples presented herein should not be construed to be limited by the specifics of FIGS. 1A and 1B.

At step 302, the workload management system may receive thermal metrics corresponding to a plurality of computing nodes (e.g., the computing nodes 102-106) hosted in the computing infrastructure (e.g., the cluster 112 of FIG. 1) over a first predefined duration. As previously described, these thermal metrics collected by the workload management system may provide a quantitative measure of heat dissipation from each computing node in the cluster 112.

Further, at step 304, the workload management system may determine a pattern of variations in the thermal metric for each of the plurality of computing nodes 102-106 over the first predefined duration. In some examples, the workload management system may analyze the collected thermal metrics by applying predictive analytics and machine-learning techniques to the thermal metrics. Furthermore, at step 306, based on the predictive analysis of the patterns of variation, the workload management system may identify a set of candidate computing nodes from the plurality of computing nodes whose thermal metrics are expected to rise above a first threshold over a second predefined duration. As will be understood, these candidate nodes may be at risk of overheating, posing a threat to system stability and hardware integrity. The first threshold may be a thermal limit beyond which the computing node's performance may degrade, and hardware components might suffer damage.

Identifying the candidate nodes may entail the workload management system comparing the predicted thermal metrics of the computing nodes against the first threshold. The computing nodes expected to exceed the first threshold may be flagged as a potential risk and are identified as the candidate computing nodes.

Moreover, at step 308, the workload management system may identify a set of target computing nodes from the plurality of computing nodes whose thermal metrics are expected to remain below a second threshold over the same second predefined duration. These target nodes are deemed thermally stable and capable of absorbing the additional thermal load from the candidate nodes. The second threshold is set lower than the first to ensure that the target nodes have sufficient thermal capacity to handle additional workloads without exceeding safe temperature limits. These target computing nodes may be identified through the same predictive analysis used to determine candidate nodes, ensuring consistency and accuracy in workload management.

After the set of target computing nodes is identified, the workload management system may begin the process of migrating one or more workloads from the set of candidate computing nodes to the set of target computing nodes to improve the thermal performance of the computing infrastructure. The migration of the workload may entail executing or more of the following operations. For example, at step 310, the workload management system may select one or more workloads from the set of candidate computing nodes based on their impact on the thermal metric of the respective computing nodes. For this selection, the workload management system may analyze the thermal metrics and the performance characteristics of each workload to determine their contribution to heat generation. In some examples, the workload management system may evaluate factors such as CPU usage, memory consumption, and I/O operations, which may directly influence the thermal output.

In some examples, in the workload selection process, at step 310, the workload management system may determine the impact of various workloads on the thermal metric for the set of candidate computing nodes. In particular, in some examples, the workload management system may utilize machine-learning models trained to predict the thermal impact of different workloads based on historical data. These machine-learning models can provide insights into which workloads are likely to cause thermal spikes and require immediate migration. Additionally, the workload management system may consider the duration and intensity of each workload's processing requirements, as prolonged high-intensity tasks are more likely to lead to overheating. By carefully selecting workloads based on their thermal impact, the workload management system ensures a balanced and efficient distribution of thermal load, enhancing the stability and longevity of the computing nodes.

At step 312, the workload management system receives information about resource utilization in each of the set of target computing nodes. This information includes the utilization of compute resources, memory resources, and networking resources. The workload management system collects this data to ensure that the target computing nodes have adequate capacity to accommodate the incoming workloads without compromising performance or efficiency. To enable such monitoring of the resource utilization, the computing nodes may be configured with respective resource monitoring agents and/or resource management software that provide real-time data on resource utilization, allowing the workload management system to make informed decisions. The workload management system may analyze metrics such as CPU load, memory usage, network bandwidth, and storage I/O to evaluate the overall capacity of each of the set of target computing nodes. This analysis helps the workload management system identify nodes that have the required resources to handle additional workloads without experiencing bottlenecks or performance degradation. By considering both thermal and resource utilization, the workload management system may ensure that the target nodes can maintain optimal performance levels while managing the incoming thermal load.

Further, at step 314, the workload management system may select a target computing node from the set of target computing nodes based on the resource utilization data received at step 312. In particular, for this selection of the target computing node, the workload management system may evaluate the resource availability and current load on each of the set of target computing nodes to ensure that it can efficiently handle the migrated workloads. In some examples, the workload management system may prioritize a target computing node with the lowest resource utilization to avoid overloading any single node and to distribute the thermal load evenly among the computing nodes in the cluster.

The selection criteria may include thresholds for CPU, memory, and network utilization, ensuring that the selected target node has sufficient headroom to accommodate additional workloads. In some examples, the workload management system may also consider the historical performance data of each node to identify those that have consistently demonstrated stability and reliability under varying load conditions. By selecting target nodes based on comprehensive resource utilization data, the workload management system ensures that the infrastructure operates efficiently and maintains optimal performance levels.

Furthermore, at step 316, the workload management system may predict one or more thermally efficient periods for the target computing node during which the thermal metric of the target computing node is expected to be lower than a predefined threshold. This prediction is based on historical thermal data, workload patterns, and environmental factors that may influence the target computing node's heat dissipation. By identifying these thermally efficient periods, the workload management system can time the workload migration to minimize the impact on the target computing node's thermal state.

In some examples, for this prediction of the thermally efficient periods, the workload management system may use predictive models, such as time-series forecasting and machine learning algorithms, to analyze past thermal data and predict future thermal behavior. These models may consider factors such as temperature variations, workload cycles, and cooling system performance. By forecasting thermally efficient periods, the workload management system can plan workload migrations during times when the target computing node is least likely to experience thermal stress. This proactive approach ensures that the migration process does not inadvertently cause overheating or performance degradation in the target computing node.

At step 318, the workload management system may commence the deployment of the selected workloads on the target computing node during the identified thermally efficient periods. This step involves initiating the migration process at a time when the target node's thermal metric is expected to be below a predefined threshold, ensuring that the node can handle the additional thermal load without overheating. The workload management system coordinates the migration to align with the predicted thermally efficient periods, optimizing both thermal performance and resource utilization. The workload deployment process at step 318 may follow industry-standard procedures to ensure seamless migration and minimal disruption. For virtual machines, live migration techniques are used to transfer the VM's state and data to the target node without downtime. For containers, orchestrated environments like Kubernetes handle pod rescheduling and data synchronization. The workload management system ensures that all necessary dependencies, configurations, and data are transferred to the target node, maintaining consistency and continuity. By timing the deployment to coincide with thermally efficient periods, the workload management system enhances the overall thermal management strategy, ensuring that the computing infrastructure operates within safe temperature limits and maintains high performance.

FIG. 4 depicts a block diagram of an example workload management system 400 in which various examples described herein may be implemented. In some examples, the workload management system 400 may be configured to operate as the workload management system 108 when deployed in the system 100 of FIGS. 1A-1B, and can perform various operations described in one or more of the earlier drawings.

The workload management system 400 may include a communication bus 402 or other communication mechanisms for communicating information (e.g., commands and/or data), a hardware processor, also referred to as processing resource 404, and a machine-readable storage medium 406 coupled to the communication bus 402 for processing information. In some examples, the machine-readable storage medium 406 may be non-transitory and is alternatively referred to as a non-transitory machine-readable storage medium 406. The machine-readable storage medium 406 may be any electronic, magnetic, optical, or any other storage device that may store data and/or executable instructions. Examples of the machine-readable storage medium that may be used in the workload management system 400 may include RAM, NVRAM, EEPROM, a storage drive (e.g., an SSD or an HDD), flash memory, and the like.

The processing resource 404 may be a physical device, for example, a CPU, a microprocessor, a GPU, an FPGA, an ASIC, and other hardware devices capable of retrieving and executing instructions stored in the machine-readable storage medium, or combinations thereof. The processing resource 404 may fetch, decode, and execute the instructions stored in the machine-readable storage medium to generate compact headers for the data units transmitted by the workload management system 108. As an alternative or in addition to executing the instructions, the processing resource 404 may include at least one integrated circuit (IC), control logic, electronic circuits, or combinations thereof that include a number of electronic components for performing the functionalities intended to be performed by the workload management system 108. In some examples, when the workload management system 400 is implemented as a virtual resource (e.g., a VM, a container, or a software application), the processing resource 404 and the machine-readable storage medium 406 may respectively represent a processing resource and a machine-readable storage medium of a host system hosting the workload management system 400 as the virtual resource.

The machine-readable storage medium 406 may store program data 408 and program instructions 410. The program data 408 may store a variety of data that may be received, used, and/or generated by the processing resource 404 as the processing resource 404 executes the program instructions 410. For example, the program data 408 may store some or all of the information shown in Tables 1 and 2. For example, the program data 408 may store information, including but not limited to, resource configuration of the computing nodes (e.g., the computing nodes 102-106 shown in FIG. 1A) and workloads (e.g., the workloads W1-W11), thermal metrics collected from the computing nodes, information useful for the identification of the computing nodes as candidate computing nodes or target computing nodes, information on target computing node for a workload identified for migration, information on thermally efficient periods suitable for migration, or combinations thereof.

The program instructions 410 may be example representative of the instructions 122 of FIG. 1A-1B. In particular, the program instructions 410 may include instructions 412, 414, 416, 418, and 420 (hereinafter collectively referred to as instructions 412-420) for performing one or more of the operations described in the method 200 of FIG. 2, for example. The processing resource 404 may fetch, decode, and execute instructions 412-420 to manage migration of workloads (e.g., the workloads W1-W11) on computing nodes (e.g., the computing nodes 102-106) in a cluster (e.g., the cluster 112). Although not shown, in some examples, the machine-readable storage medium 406 may be encoded with certain additional executable instructions to perform one or more other operations (e.g., operations described in FIG. 3) performed by the workload management system, without limiting the scope of the present disclosure.

In some examples, the instructions 412-420, when executed by the processing resource 404, may cause the processing resource 404 to efficiently migrate one or more of the workload to thermally efficient computing nodes, thereby improving the overall thermal efficiency of the computing nodes in a cluster. For example, the instructions 412, when executed by the processing resource 404, may cause the processing resource 404 to receive a thermal metric corresponding to a plurality of computing nodes over a first predefined duration. Further, the instructions 414, when executed by the processing resource 404, may cause the processing resource 404 to determine a pattern of variations in the thermal metric for each of the plurality of computing nodes over the first predefined duration. Furthermore, the instructions 416, when executed by the processing resource 404, may cause the processing resource 404 to identify, based on a predictive analysis of the pattern of variations, a set of candidate computing nodes from the plurality of computing nodes whose thermal metric is expected to rise above a first threshold over a second predefined duration.

Furthermore, the instructions 418, when executed by the processing resource 404, may cause the processing resource 404 to identify, based on the predictive analysis of the pattern of variations, a set of target computing nodes from the plurality of computing nodes whose thermal metric is expected to remain below a second threshold over the second predefined duration, wherein the second threshold is lower than the first threshold. Additionally, the instructions 420, when executed by the processing resource 404, may cause the processing resource 404 to migrate one or more workloads from the set of candidate computing nodes to the set of target computing nodes.

Further, in some examples, the workload management system 400 may also include a network interface 422 coupled to the communication bus 402. The network interface 422 provides a two-way data communication coupling to one or more network links that are connected to one or more networks (e.g., the network 110). For example, the network interface 422 may be an integrated services digital network (ISDN) card, cable modem, satellite modem, or a modem to provide a data communication connection to a corresponding type of telephone line. As another example, the network interface 422 may be a local area network (LAN) card or a wireless communication unit (e.g., Wi-Fi chip/module).

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. The term “based on” means based at least in part on.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. A workload management system comprising:
a non-transitory machine-readable storage medium storing executable instructions; and
a processing resource connected to the non-transitory machine-readable storage medium and configured to execute one or more of the instructions to:
receive a thermal metric corresponding to a plurality of computing nodes over a first predefined duration;
determine a pattern of variations in the thermal metric for each of the plurality of computing nodes over the first predefined duration;
identify, based on a predictive analysis of the pattern of variations, a set of candidate computing nodes from the plurality of computing nodes whose thermal metric is expected to rise above a first threshold over a second predefined duration;
identify, based on the predictive analysis of the pattern of variations, a set of target computing nodes from the plurality of computing nodes whose thermal metric is expected to remain below a second threshold over the second predefined duration, wherein the second threshold is lower than the first threshold; and
migrate one or more workloads from the set of candidate computing nodes to the set of target computing nodes.

2. The workload management system of claim 1, wherein the processing resource is configured to execute one or more of the instructions to predict one or more thermally efficient periods for the set of target computing nodes during which the thermal metric corresponding to the set of target computing nodes is expected to remain lower than a predefined threshold.

3. The workload management system of claim 2, wherein, to migrate the one or more workloads, the processing resource is configured to execute one or more of the instructions to deploy the one or more workloads on the set of target computing nodes during the one or more thermally efficient periods.

4. The workload management system of claim 1, wherein the processing resource is configured to execute one or more of the instructions to select the one or more workloads based on an impact of the one or more workloads on the thermal metric for the set of candidate computing nodes.

5. The workload management system of claim 1, wherein the processing resource is configured to execute one or more of the instructions to receive information about resource utilization in each of the set of target computing nodes.

6. The workload management system of claim 5, wherein the processing resource is configured to execute one or more of the instructions to:
select a target computing node from the set of target computing nodes based on the resource utilization in each of the set of target computing nodes; and
commence deployment of the one or more workloads on the selected target computing node.

7. The workload management system of claim 1, wherein the processing resource is configured to execute one or more of the instructions to train a machine learning model using values of the thermal metric collected over a third predefined duration.

8. The workload management system of claim 7, wherein identifying the set of candidate computing nodes and identifying the set of target computing nodes comprises identifying the set of candidate computing nodes and the set of target computing nodes using the machine learning model.

9. The workload management system of claim 1, wherein the thermal metric is a measure of heat dissipation.

10. The workload management system of claim 1, wherein a workload of the one or more workloads comprises a virtual machine, a container, a pod, an application, a service, or combinations thereof.

11. The workload management system of claim 1, wherein one or more of the first predefined duration, the second predefined duration, the first threshold, or the second threshold are customizable.

12. A method for managing workloads in a computing infrastructure, the method comprising:
receiving, by a workload management system, a thermal metric corresponding to a plurality of computing nodes hosted in the computing infrastructure over a first predefined duration;
determining, by the workload management system, a pattern of variations in the thermal metric for each of the plurality of computing nodes over the first predefined duration;
identifying, by the workload management system based on a predictive analysis of the pattern of variations, a set of candidate computing nodes from the plurality of computing nodes whose thermal metric is expected to rise above a first threshold over a second predefined duration;
identifying, by the workload management system based on the predictive analysis of the pattern of variations, a set of target computing nodes from the plurality of computing nodes whose thermal metric is expected to remain below a second threshold over the second predefined duration, wherein the second threshold is lower than the first threshold; and
migrating, by the workload management system, one or more workloads from the set of candidate computing nodes to the set of target computing nodes to improve thermal performance of the computing infrastructure.

13. The method of claim 12, wherein the thermal metric is a measure of heat dissipation.

14. The method of claim 12, further comprising selecting the one or more workloads based on an impact of the one or more workloads on the thermal metric for the set of candidate computing nodes.

15. The method of claim 12, further comprising receiving information about resource utilization in each of the set of target computing nodes, wherein the information about resource utilization comprises utilization of compute resources, memory resources, or networking resources of the set of target computing nodes.

16. The method of claim 15, wherein migrating the one or more workloads comprises selecting, by the workload management system, a target computing node from the set of target computing nodes based on the resource utilization in each of the set of target computing nodes.

17. The method of claim 16, wherein migrating the one or more workloads comprises predicting one or more thermally efficient periods for the target computing node during which the thermal metric corresponding to the target computing node is expected to be lower than a predefined threshold.

18. The method of claim 17, wherein migrating the one or more workloads comprises commencing deployment of the one or more workloads on the target computing node during the one or more thermally efficient periods.

19. A non-transitory machine-readable storage medium storing instructions executable by a processing resource, wherein the instructions comprise:
instructions to receive a thermal metric corresponding to a plurality of computing nodes over a first predefined duration;
instructions to determine a pattern of variations in the thermal metric for each of the plurality of computing nodes over the first predefined duration;
instructions to identify, based on a predictive analysis of the pattern of variations, a set of candidate computing nodes from the plurality of computing nodes whose thermal metric is expected to rise above a first threshold over a second predefined duration;
instructions to identify, based on the predictive analysis of the pattern of variations, a set of target computing nodes from the plurality of computing nodes whose thermal metric is expected to remain below a second threshold over the second predefined duration, wherein the second threshold is lower than the first threshold; and
instructions to migrate one or more workloads from the set of candidate computing nodes to the set of target computing nodes.

20. The non-transitory machine-readable storage medium of claim 19, wherein the instructions further comprise:
instructions to predict one or more thermally efficient periods for the set of target computing nodes during which the thermal metric corresponding to the set of target computing nodes is expected to remain lower than a predefined threshold; and
instructions to deploy the one or more workloads on the set of target computing nodes during the one or more thermally efficient periods.
